(19) United States
(12) Patent Application Publication
(10) Pub. No.: US 2009/0021573 A1
(43) Pub. Date: Jan. 22, 2009

(54) APPARATUS AND METHOD FOR OUTPUTTING DIGITAL BROADCASTING IN A MOBILE TERMINAL HAVING CAMERA

(75) Inventors: Sung-Gu KIM, Gumi-si (KR); Dong-Sub KIM, Kumi-shi (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/171,738

(22) Filed: Jul. 11, 2008

(30) Foreign Application Priority Data
Jul. 16, 2007 (KR) 2007-71227

(51) Int. Cl. H04N 7/14; H04H 40/00

(52) U.S. Cl. 348/14.02; 455/3.06; 348/E07.078

(57) ABSTRACT

An apparatus and method for outputting digital broadcasting in a mobile terminal having a camera are provided. In the apparatus and method, a digital broadcasting receiver receives digital broadcasting data of a broadcasting channel selected by a user in a digital broadcasting mode, a controller switches an operational mode of the mobile terminal from preview mode to the digital broadcasting mode, if a preset key is actuated for a preset time in the preview mode for previewing an image of an object to be captured by the camera, and an output section outputs the digital broadcasting data received at the digital broadcasting receiver.

### PRIORITY

This application claims the benefit under 35 U.S.C. § 119(a) of a Korean patent application filed in the Korean Intellectual Property Office on Jul. 16, 2007 and assigned Serial No. 2007-71227, the entire disclosure of which is hereby incorporated by reference.

### BACKGROUND OF THE INVENTION

1. Field of the Invention

The present invention relates to a mobile terminal having a camera, which is capable of receiving digital broadcasting. More particularly, the present invention relates to an apparatus and method for outputting digital broadcasting by transitioning from a preview mode in which a user previews an image of an object to be captured by a camera into a digital broadcasting mode.

2. Description of the Related Art

Recently, mobile terminals have been equipped with diverse functions in order to satisfy a variety of user demands. More popular functions are a multimedia function for transmitting data and images, as well as mail, Internet browsing, and gaming functions.

Also, a function for displaying moving pictures is implemented in mobile terminals by use of a camera or a digital broadcasting receiver (e.g. a satellite digital broadcasting receiver, a terrestrial digital broadcasting receiver, a digital TV receiver, etc.).

Therefore, mobile terminals are enabled to execute a camera function for capturing, displaying, and transmitting an image of an object by a camera and a digital broadcasting output function for receiving and outputting digital broadcasting.

When a user requests the digital broadcasting output function, a camera and digital broadcasting-enabled mobile terminal should enter a digital broadcasting mode according to the user's menu input after terminating a preview mode. The same thing occurs when the mobile terminal switches from the digital broadcasting output function to the camera function.

The mode transition between the camera function and the digital broadcasting output function takes a plurality of key inputs from the user. The numerous key inputs results in an unnecessary time delay and therefore and is an inconvenience to the user.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for outputting digital broadcasting in a mobile terminal, which facilitates transitioning between a camera mode and a digital broadcasting mode.

In accordance with an aspect of the present invention, an apparatus for outputting digital broadcasting in a mobile terminal having a camera is provided. The apparatus includes a digital broadcasting receiver for receiving digital broadcasting data of a broadcasting channel selected by a user in a digital broadcasting mode, a controller for switching an operational mode of the mobile terminal from a preview mode to the digital broadcasting mode, if a preset key is actuated for a preset time in the preview mode for previewing an image of an object to be captured by the camera, and an output section for outputting the digital broadcasting data received at the digital broadcasting receiver.

In accordance with another aspect of the present invention, a method for outputting digital broadcasting in a mobile terminal having a camera is provided. The method includes switching an operational mode of the mobile terminal from a preview mode for previewing an image of an object to be captured by the camera to a digital broadcasting mode, if a preset key is actuated for a preset time in the preview mode, receiving digital broadcasting data of a broadcasting channel selected by a user, and outputting the digital broadcasting data in the digital broadcasting mode.

In accordance with a further aspect of the present invention, a method for outputting digital broadcasting in a mobile terminal having a camera is provided. The method includes displaying information about one or more broadcasting channels at a preset position on a preview screen, if a preset key is actuated for a preset time in a preview mode for previewing an object of an image to be captured by the camera, switching an operational mode of the mobile terminal to a digital broadcasting mode, if a broadcasting channel is selected from among the broadcasting channels, receiving broadcasting data of the selected broadcasting channel, and outputting the broadcasting data.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram of a mobile terminal according to an exemplary embodiment of the present invention;

FIG. 2 is a flowchart illustrating an operation for outputting digital broadcasting in a mobile terminal according to an exemplary embodiment of the present invention; and

FIG. 3 is a flowchart illustrating an operation for outputting digital broadcasting in a mobile terminal according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

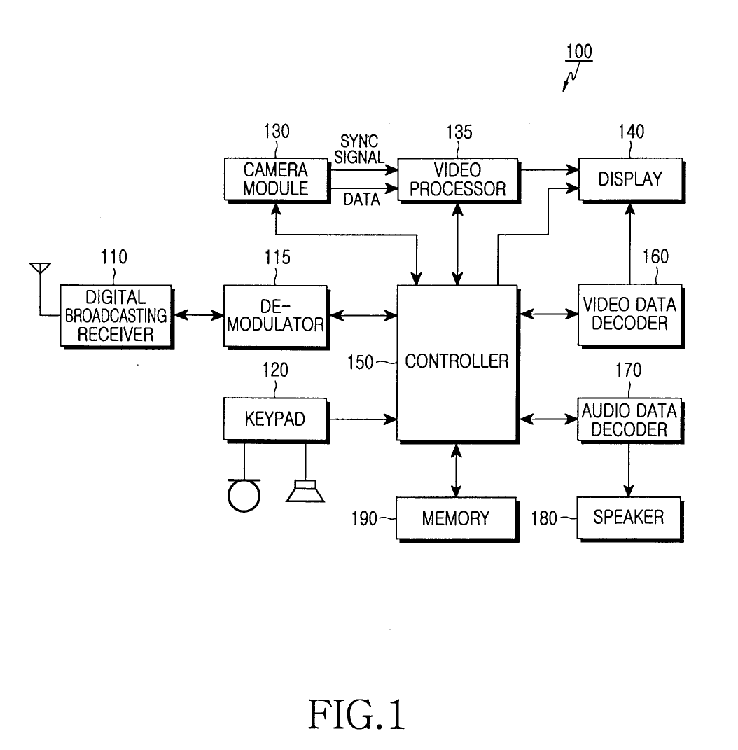

FIG. 1 is a block diagram of a mobile terminal according to an exemplary embodiment of the present invention.

Referring to FIG. 1, a mobile terminal 100 includes a digital broadcasting receiver 110, a demodulator 115, a keypad 120, a camera module 130, a video processor 135, a display 140, a controller 150, a video data decoder 160, an audio data decoder 170, a speaker 180, and a memory 190.

The digital broadcasting receiver 110 receives digital broadcasting data of a preset broadcasting channel under the control of the controller 150.

The demodulator 115 demodulates the digital broadcasting data received from the digital broadcasting receiver 110 into a digital data stream.

The keypad 120 is configured in a key matrix (not shown). The keypad 120 may be provided with alphabet keys, digit keys, function keys, and volume keys, for providing a key input signal corresponding to a user input to the controller 150. The keypad 120 may also have camera operation keys at preset positions, including a camera power key used when a camera mode is entered, a zoom key for controlling a zoom level (i.e. a magnification), and a shutter key for capturing an image.

The camera module 130 may include an extendable lens unit (not shown). Upon receipt of a shutter key input, the camera module 130 captures an image of an object through the lens unit.

The camera module 130 also includes a camera sensor (not shown) for converting a captured optical signal to an electrical signal and a signal processor (not shown) for converting an analog video signal received from the camera sensor into digital data.

Herein, the camera sensor may be any of a Charge Coupled Device (CCD) sensor, a Complementary Metal-Oxide Semiconductor (CMOS) sensor and the like. The signal processor can be implemented by a Digital Signal Processor (DSP). The camera sensor and the signal processor can be incorporated into a single device, or they can be configured separately.

The video processor 135 functions to generate screen data in order to display a video signal received from the camera module 130. The video processor 135 processes the received video signal on a frame basis and outputs the frame video data according to the characteristics and size of the display 140. The video processor 135 includes a video Coder-Decoder (CODEC), for compressing frame video data displayed on the display 140 or decompressing compressed frame video data to the original frame video data in a preset method.

The video processor 135 may have an On Screen Display (OSD) function. Thus, the video processor 135 can output OSD data according to a screen size.

The display 140 may include a Liquid Crystal Display (LCD). The display 140 outputs screen data generated in the mobile terminal 100. When the LCD is implemented in the form of a touch screen, the display 140 can function as an input section.

The display 140 displays a video signal received from the video processor 135 and user data received from the controller 150.

The controller 150 provides overall control to the operations of the mobile terminal 100 according to an exemplary embodiment of the present invention. The controller 150 parses the digital broadcasting stream received from the demodulator 115 into an audio data stream and a video data stream and outputs the audio data stream and the video data stream to the display 140 and the speaker 180 via the video data decoder 160 and the audio data decoder 170. In accordance with an exemplary embodiment of the present invention, the display 140 and the speaker 180 function as an output section.

Upon receipt of a camera mode request from the user, the controller 150 transitions the operational mode of the mobile terminal 100 to a preview mode in which the user reviews an image of an object to be captured by the camera module 130.

When a preset key is actuated for a preset time period (e.g. one second or two seconds) in the preview mode, the controller 150 controls the operational mode of the mobile terminal 100 to transition from the preview mode to digital broadcasting mode. The preset key may be one of the keys provided in the keypad 120, preset for transitions between the preview mode and the digital broadcasting mode. Alternatively, the preset key may be separately provided for transitions between the preview mode and the digital broadcasting mode.

When the preset key is actuated for the preset time period, the controller 150 may first output a message asking the user whether he wants to transition to the digital broadcasting mode and, only if the user permits the transition, for example by actuating an OK key, controls the mobile terminal 100 to transition from the preview mode to the digital broadcasting mode.

In the digital broadcasting mode, the controller 150 controls the mobile terminal 100 to receive and output one of digital broadcasting data of a last broadcasting channel selected in the previous digital broadcasting mode and digital broadcasting data of a user-selected broadcasting channel in the current digital broadcasting mode.

When the preset key is actuated for a preset time period or upon receipt of a request for terminating the digital broadcasting mode while outputting digital broadcasting data, the controller 150 may control the operational mode to return to the preview mode.

The controller 150 may control the mobile terminal 100 to transition from the digital broadcasting mode to the preview mode after outputting a message asking the user whether he wants to transition to the preview mode and receiving a permission from the user.

In another exemplary embodiment of the present invention, the controller 150 can control information about digital broadcasting channels to be displayed at a preset position of a preview screen without transitioning to the digital broadcasting mode, when the preset key is actuated for the preset time in the preview mode. Although the broadcasting channel information may be information about currently available broadcasting channels, the broadcasting channel information can be information about timetable-based broadcasting programs of each broadcasting channel. The broadcasting channel information may include at least one of information about broadcasting stations, titles of broadcasting programs and the like.

Upon user selection of a broadcasting channel from among the displayed broadcasting channels, the controller 150 may control the mobile terminal 100 to transition to the digital broadcasting mode and receive digital broadcasting data of the selected broadcasting channel. However, the controller 150 may control the mobile terminal 100 to transition to the digital broadcasting mode only after the preset key has been actuated for a preset time period or longer with the broadcasting channel selected. In this case, the controller 150 can control information about timetable-based broadcasting programs of the selected broadcasting channel to be displayed each time the user enters an up/down directional key with the broadcasting channel selected.

The video data decoder 160 decodes the received video data stream into an analog video signal and provides the analog video signal to the display 140 under the control of the controller 150.

The audio data decoder 170 decodes the received audio data stream into an analog audio signal and provides the analog audio signal to the speaker 180 under the control of the controller 150.

The memory 190 may include a program memory and a data memory. The memory 190 stores information required for control of the operations of the mobile terminal 100 and information corresponding to user selections according to an exemplary embodiment of the present invention. The memory 190 also stores digital broadcasting program guide data received through the digital broadcasting receiver 110 under the control of the controller 150. The digital broadcasting program guide data can be updated every preset interval under the control of the controller 150.

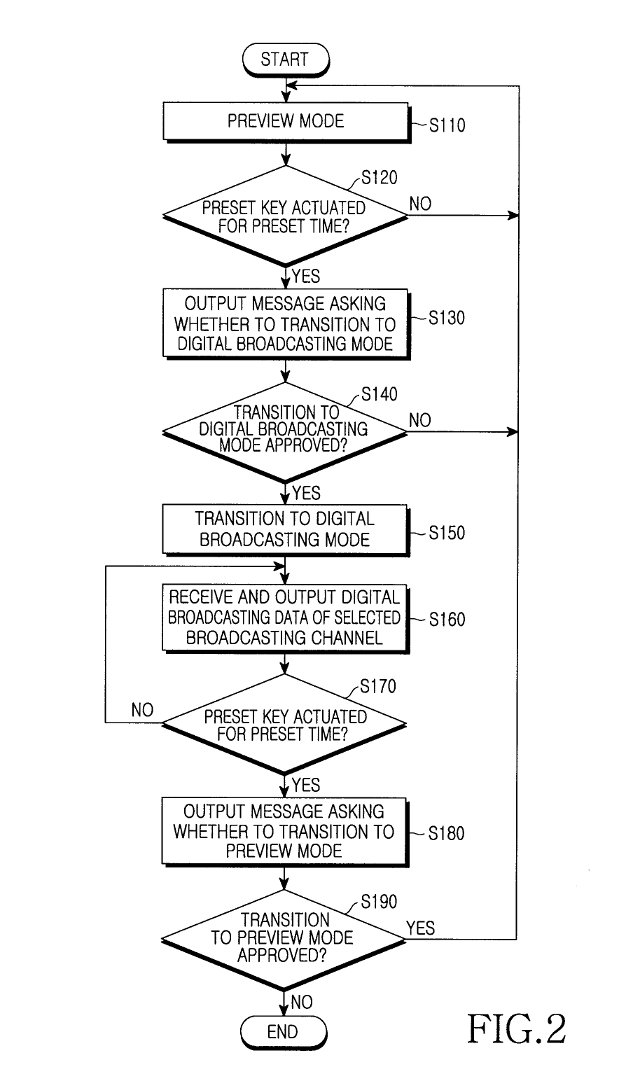

FIG. 2 is a flowchart illustrating an operation for outputting digital broadcasting in the mobile terminal according to an exemplary embodiment of the present invention.

Referring to FIGS. 1 and 2, upon receipt of a camera mode request from the user, the controller 150 performs the preview mode in which the user previews an image of an object to be captured by the camera module 130 in step S110. The user can request the camera mode by entering one of a menu key, the camera power key used for entering the camera mode, and the like.

In step S120, the controller 150 monitors whether a preset key is actuated for a preset time period (e.g. one second or two seconds) in the preview mode. The preset key is one of the keys provided in the keypad 120, preset for transitions between the preview mode and the digital broadcasting mode. Alternatively, the preset key may be separately provided for transitions between the preview mode and the digital broadcasting mode.

If the preset key is actuated for the preset time period in the preview mode, the controller 150 outputs a message asking the user whether to transition to the digital broadcasting mode, for example, “Do you want to switch to the digital broadcasting mode?” to the display 140 or the speaker 180 in step S130. The message can be a text message or a voice message, or both.

The controller 150 monitors whether the user accepts the transition to the digital broadcasting mode, that is, whether the user has actuated an OK key indicating an affirmative answer to the inquiry message in step S140.

If the user accepts the transition to the digital broadcasting mode, the controller 150 switches the operational mode of the mobile terminal 100 from the preview mode to the digital broadcasting mode in step S150. While the exemplary embodiment of the present invention involves the step of outputting an inquiry message regarding transitioning to the digital broadcasting mode when a preset key is actuated for a preset time, the digital broadcasting mode can be entered directly without outputting the message.

The controller 150 receives digital broadcasting data of a user-selected broadcasting channel and outputs the digital broadcasting data in the digital broadcasting mode in step S160. The controller 150 may control so that digital broadcasting data of a last selected broadcasting channel in the previous digital broadcasting mode is received and output when the digital broadcasting mode is entered. For instance, if channel 7 is the last channel that the user viewed, the controller 150 receives and outputs digital broadcasting data of channel 7 when the digital broadcasting mode is entered.

The controller 150 determines whether a preset key has been actuated for a preset time (e.g. one second or two seconds) while outputting the digital broadcasting data in step S170.

If the preset key has been actuated for the preset time or longer, the controller 150 outputs a message asking the user whether to transition to the preview mode in step S180. Alternatively, upon receipt of a request for terminating the digital broadcasting mode (e.g. by an end key), the controller 150 can perform step S180.

In step S190, the controller 150 determines whether the user has accepted the transition to the preview mode, that is, whether an OK key is actuated, indicating the user's approval of the transition to the preview mode.

If the transition to the preview mode has been approved, the controller 150 performs the preview mode in step S110. If the transition to the preview mode has not been approved, the controller 150 ends the procedure.

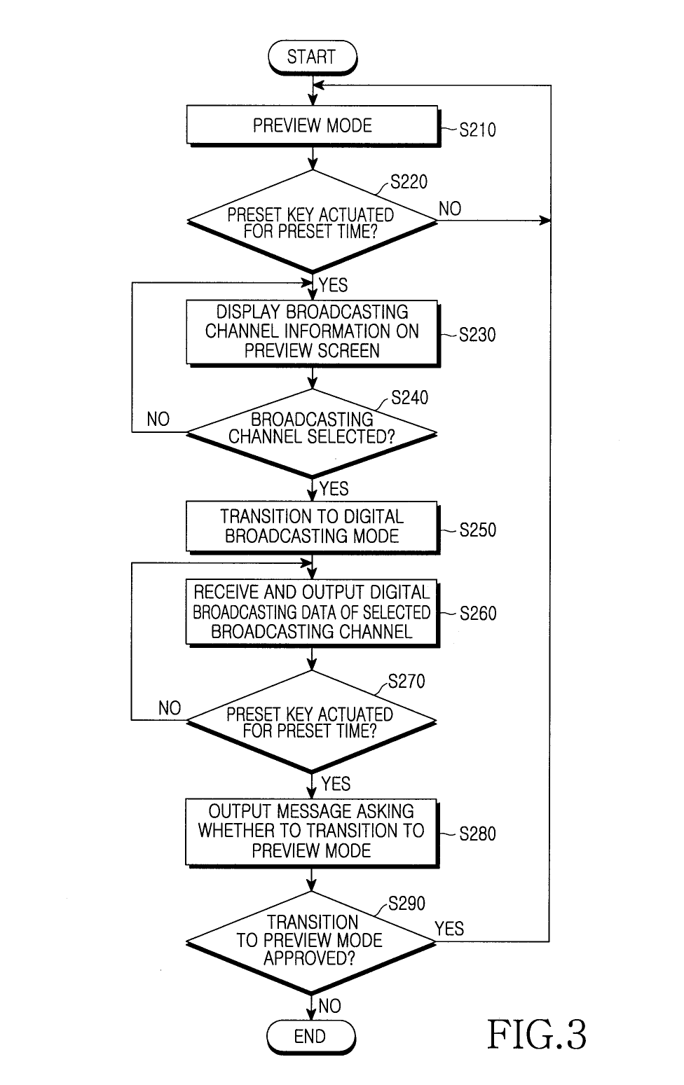

FIG. 3 is a flowchart illustrating an operation for outputting digital broadcasting in the mobile terminal according to another exemplary embodiment of the present invention.

Referring to FIGS. 1 and 3, upon receipt of a camera mode request from the user, the controller 150 performs the preview mode in which the user previews an image of an object to be captured by the camera module 130 in step S210.

In step S220, the controller 150 monitors whether a preset key is actuated for a preset time period (e.g. one second or two seconds) in the preview mode. The preset key is a key preset for transitions between the preview mode and the digital broadcasting mode.

If the preset key is actuated for the preset time period in the preview mode, the controller 150 detects broadcasting channel information from digital broadcasting program guide data stored in the memory 190 and displays the broadcasting channel information at a preset position on a preview screen in step S230. Although the broadcasting channel information is preferably information about currently available broadcasting channels, it can be information about timetable-based broadcasting programs of each broadcasting channel. The broadcasting channel information may include at least one of information about broadcasting stations, the titles of broadcasting programs and the like. The operation of the controller 150 for generating broadcasting channel information from digital broadcasting program guide data is well known in the field and thus it will not described in detail herein.

The controller 150 monitors whether the user has selected a broadcasting channel from the displayed broadcasting channel information in step S240.

Upon user selection of a broadcasting channel, the controller 150 switches the operational mode of the mobile terminal 100 from the preview mode to the digital broadcasting mode in step S250. Alternatively, the controller 150 can control so that the digital broadcasting mode is entered only if the preset key is actuated for a preset time period or longer with a broadcasting channel selected. In this case, the controller 150 may control so that each time an up/down key is entered with the broadcasting channel selected, timetable-based broadcasting information of the broadcasting channel is displayed.

The controller 150 receives digital broadcasting data of the selected broadcasting channel and outputs the digital broadcasting data in the digital broadcasting mode in step S260.

The controller 150 determines whether a preset key has been actuated for a preset time or longer while outputting the digital broadcasting data in step S270.

If the preset key has been actuated for the preset time or longer, the controller 150 outputs a message asking the user whether to transition to the preview mode in step S280. However, upon receipt of a request for terminating the digital broadcasting mode, the controller 150 can also perform step S280.

In step S290, the controller 150 determines whether the user has accepted the transition to the preview mode, that is, whether an OK key is actuated, indicating the user's approval of the transition to the preview mode.

If the transition to the preview mode has been approved, the controller 150 performs the preview mode in step S210. If the transition to the preview mode has not been approved, the controller 150 ends the procedure.

As is apparent from the above description, exemplary embodiments of the present invention advantageously facilitate operational transitions between a camera mode and a digital broadcasting mode without requiring a plurality of user's key inputs. Therefore, user convenience is increased.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. An apparatus for outputting digital broadcasting in a mobile terminal having a camera, the apparatus comprising:
a digital broadcasting receiver for receiving digital broadcasting data of a broadcasting channel selected by a user in a digital broadcasting mode;
a controller for switching an operational mode of the mobile terminal from a preview mode to the digital broadcasting mode, if a preset key is actuated for a preset time in the preview mode for previewing an image of an object to be captured by the camera; and
an output section for outputting the digital broadcasting data received at the digital broadcasting receiver.

2. The apparatus of claim 1, wherein the preset key is a key provided on the mobile terminal that is preset for transitioning between the preview mode and the digital broadcasting mode.

3. The apparatus of claim 1, wherein if the preset key is actuated for the preset time in the preview mode, the controller outputs a message asking whether to transition to the digital broadcasting mode, and upon receipt of an response indicating approval of the transition to the digital broadcasting mode, switches the operational mode of the mobile terminal from the preview mode to the digital broadcasting mode.

4. The apparatus of claim 1, wherein when the operational mode of the mobile terminal transitions to the digital broadcasting mode, the controller controls digital broadcasting data of a last broadcasting channel selected in a previous digital broadcasting mode to be received and output.

5. The apparatus of claim 1, wherein if the preset key is actuated for a preset time in the digital broadcasting mode, the controller returns the operational mode of the mobile terminal to the preview mode.

6. The apparatus of claim 5, wherein if the preset key is actuated for the preset time in the digital broadcasting mode, the controller outputs a message asking whether to transition to the preview mode.

7. The apparatus of claim 1, wherein upon receipt of a request for terminating the digital broadcasting mode, the controller returns the operational mode of the mobile terminal to the preview mode.

8. The apparatus of claim 7, wherein upon receipt of the request for terminating the digital broadcasting mode, the controller outputs a message asking whether to transition to the preview mode.

9. The apparatus of claim 1, wherein if the preset key is actuated for the preset time in the preview mode, the controller controls information about one or more broadcasting channels to be displayed on a preset position of a preview screen.

10. The apparatus of claim 9, wherein if a broadcasting channel is selected from among the one or more broadcasting channels, the controller transitions the operational mode of the mobile terminal to the digital broadcasting mode and controls broadcasting data of the selected broadcasting channel to be received and output.

11. The apparatus of claim 10, wherein if the preset key is actuated for a preset time or longer after the broadcasting channel is selected, the controller transitions the operational mode of the mobile terminal to the digital broadcasting mode.

12. The apparatus of claim 11, wherein each time a directional key is entered after the broadcasting channel is selected, the controller controls timetable-based broadcasting program information of the selected broadcasting channel to be displayed.

13. A method for outputting digital broadcasting in a mobile terminal having a camera, the method comprising:
switching an operational mode of the mobile terminal from a preview mode for previewing an image of an object to be captured by the camera to a digital broadcasting mode, if a preset key is actuated for a preset time in the preview mode;
receiving digital broadcasting data of a broadcasting channel selected by a user; and
outputting the digital broadcasting data in the digital broadcasting mode.

14. The method of claim 13, wherein the preset key is a key provided on the mobile terminal that is preset for transitioning between the preview mode and the digital broadcasting mode.

15. The method of claim 13, wherein the switching of the operational mode comprises:
outputting a message asking whether to transition to the digital broadcasting mode, if the preset key is actuated for the preset time in the preview mode; and
switching the operational mode of the mobile terminal from the preview mode to the digital broadcasting mode, upon receipt of a response indicating approval of the transition to the digital broadcasting mode.

16. The method of claim 13, wherein the reception of the digital broadcasting data comprises receiving digital broadcasting data of a last broadcasting channel selected in a previous digital broadcasting mode.

17. The method of claim 13, further comprising, upon receipt of a request for terminating the digital broadcasting mode, returning the operational mode of the mobile terminal to the preview mode.

18. The method of claim 17, wherein the returning of the operational mode of the mobile terminal to the preview mode comprises outputting a message asking whether to transition to the preview mode, upon receipt of the request for terminating the digital broadcasting mode.

19. The method of claim 13, further comprising returning the operational mode of the mobile terminal to the preview mode, if the preset key is actuated for a preset time in the digital broadcasting mode.

20. The method of claim 19, wherein the returning of the operational mode of the mobile terminal to the preview mode comprises outputting a message asking whether to transition to the preview mode, if the preset key is actuated for the preset time in the digital broadcasting mode.

21. A method for outputting digital broadcasting in a mobile terminal having a camera, the method comprising:
displaying information about one or more broadcasting channels at a preset position on a preview screen, if a preset key is actuated for a preset time in a preview mode for previewing an object of an image to be captured by the camera;
switching an operational mode of the mobile terminal to a digital broadcasting mode, if a broadcasting channel is selected from among the broadcasting channels;
receiving broadcasting data of the selected broadcasting channel; and
outputting the broadcasting data.

22. The method of claim 21, wherein the preset key is a key provided on the mobile terminal that is preset for transitioning between the preview mode and the digital broadcasting mode.

23. The method of claim 21, wherein the switching of an operational mode of the mobile terminal to a digital broadcasting mode comprises switching the operational mode of the mobile terminal to the digital broadcasting mode, if the preset key is actuated for a preset time or longer after the broadcasting channel is selected.

24. The method of claim 23, wherein the switching of an operational mode of the mobile terminal to a digital broadcasting mode comprises displaying timetable-based broadcasting program information of the selected broadcasting channel, each time a directional key is entered after the broadcasting channel is selected.

25. The method of claim 21, further comprising, upon receipt of a request for terminating the digital broadcasting mode, returning the operational mode of the mobile terminal to the preview mode.

26. The method of claim 25, wherein the returning of the operational mode of the mobile terminal to the preview mode comprises outputting a message asking whether to transition to the preview mode, upon receipt of the request for terminating the digital broadcasting mode.

27. The method of claim 21, further comprising returning the operational mode of the mobile terminal to the preview mode, if the preset key is actuated for a preset time in the digital broadcasting mode.

28. The method of claim 27, wherein the returning of the operational mode of the mobile terminal to the preview mode comprises outputting a message asking whether to transition to the preview mode, if the preset key is actuated for the preset time in the digital broadcasting mode.
